(19) United States
(12) Patent Application Publication
(10) Pub. No.: US 2012/0233140 A1
(43) Pub. Date: Sep. 13, 2012

(54) CONTEXT-AWARE QUERY ALTERATION

(75) Inventors: Kevyn B. Collins-Thompson, Seattle, WA (US); Ni Lao, Pittsburgh, PA (US)

(73) Assignee: Microsoft Corporation, Redmond, WA (US)

(21) Appl. No.: 13/043,500

(22) Filed: Mar. 9, 2011

(51) Int. Cl. G06F 17/30

(52) U.S. Cl. 707/706; 707/748; 707/E17.108; 707/E17.014

(57) ABSTRACT

A model generation module is described herein for using a machine learning technique to generate a model for use by a search engine. The model assists the search engine in generating alterations of search queries, so as to improve the relevance and performance of the search queries. The model includes a plurality of features having weights and levels of uncertainty associated therewith, where each feature defines a rule for altering a search query in a defined manner when a context condition, specified by the rule, is present. The model generation module generates the model based on user behavior information, including query reformulation information and user preference information. The query reformulation information indicates query reformulations made by at least one agent (such as users). The preference information indicates at extent to which the users were satisfied with the query reformulations.

### BACKGROUND

A user's search query may not be fully successful in retrieving relevant documents. This is because the search query may use terms that are not contained in or otherwise associated with the relevant documents. To address this situation, search engines commonly provide an alteration module which automatically modifies a search query to make it more effective in retrieving the relevant documents. Such modification can entail adding term(s) to the original search query, removing term(s) from the original search query, replacing term(s) in the original search query with other term(s), correcting term(s) in the original search query, and so on. More specifically, such modification may encompass spelling correction, selective stemming, acronym normalization, query expansion (e.g., by adding synonyms, etc.), and so on. In one case, a human agent may manually create the rules which govern the manner of operation of the alteration module.

On average, an alteration module can be expected to improve the ability of a search engine to retrieve relevant documents. However, the alteration module may suffer from other shortcomings. In some cases, for instance, the alteration module may incorrectly interpret a term in the original search query. This results in the modification of the original search query in a manner that significantly subverts the intended meaning of the original search query. Based on this altered query, the search engine may identify a set of documents which is completely irrelevant to the user's search objectives. Such a dramatic instance of poor performance can bias a user against future use of the search engine, even though the alteration module is, on average, improving the performance of the search engine. Moreover, it may be a time-intensive and burdensome task for developers of the search engine to manually specify the rules which govern the operation of the alteration module.

The challenges noted above are presented by way of example, not limitation. Search engine technology may suffer from yet other shortcomings.

### SUMMARY

A model generation module is described herein for using a machine-learning technique to generate a model for use by a search engine, where that model assists the search engine in altering search queries. According to one illustrative implementation, the model generation module operates by receiving query reformulation information that describes query reformulations made by at least one agent (such as a plurality of users). The model generation module also receives preference information which indicates behavior performed by the users that is responsive to the query reformulations. For example, the preference information may identify user selections of items within search results, where those search results are generated in response to the query reformulations. The model generation module then generates labeled reformulation information based on the query reformulation information and the preference information. The labeled reformulation information includes tags which indicate an extent to which the query reformulations were deemed satisfactory by the users. The model generation module then generates a model based on the labeled reformulation information. The model provides functionality, for use by the search engine, at query time, for mapping search queries to query alterations.

More specifically, the model comprises a plurality of features having weights associated therewith. Each feature defines a rule for altering a search query in a defined manner when a context condition, specified by the feature, is deemed to apply to the search query. Optionally, each feature (and/or combination of features) may also have a level of uncertainty associated therewith.

The search engine can operate in the following manner at query time, e.g., once the above-described model is installed in the search engine. The search engine begins by receiving a search query. The search engine then uses the model to identify at least one candidate alteration of the search query (if there is, in fact, at least one candidate alteration). Each candidate alteration matches at least one feature in a set of features specified by the model. The search engine then generates at least one recommended alteration of the search query (if possible), selected from among the candidate alteration(s), e.g., based on score(s) associated with the candidate alteration(s).

As will be described herein, the model improves the ability of the search engine to generate relevant search results. In certain implementations, the search engine can also be configured to conservatively discount individual features and/or combinations of features that have high levels of uncertainty associated therewith. This provision operates to further reduce the risk that the search engine will select incorrect alterations of search queries.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an environment that includes a search engine and a model generation module. The model generation module uses a machine learning technique to generate a model for use by the search engine in generating query alterations of search queries.

FIGS. 2-5 together provide a simplified example of one manner of operation of the environment shown in FIG. 1.

FIG. 6 shows one implementation of the environment shown in FIG. 1.

FIG. 7 shows one implementation of the model generation module shown in FIG. 1.

FIGS. 8 and 9 provide illustrative details regarding one manner of operation of a label application module provided by the model generation module of FIG. 7.

FIG. 10 is a table that shows an illustrative set of context conditions associated with model features.

FIG. 11 shows one implementation of a training module provided by the model generation module of FIG. 7.

FIG. 12 shows one implementation of a context-aware query alteration module provided by the search engine of FIG. 1.

FIG. 13 is a flowchart that shows one manner of operation of the model generation module of FIG. 1.

FIG. 14 is a flowchart that shows additional details regarding the operation of the model generation module of FIG. 1.

FIG. 15 is a flowchart that shows one manner of operation of the search engine shown in FIG. 1.

FIG. 16 is a high-level representation of a procedure for generating parameter information, used to produce a Naïve Bayes model.

FIG. 17 shows illustrative processing functionality that can be used to implement any aspect of the features shown in the foregoing drawings.

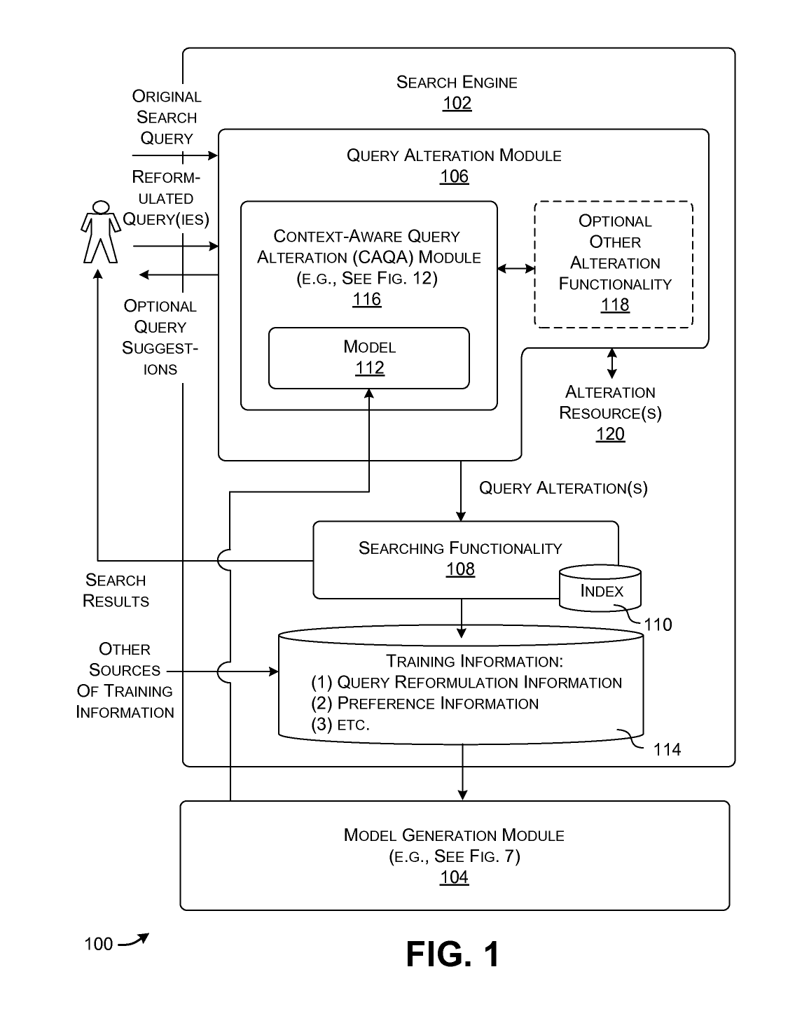

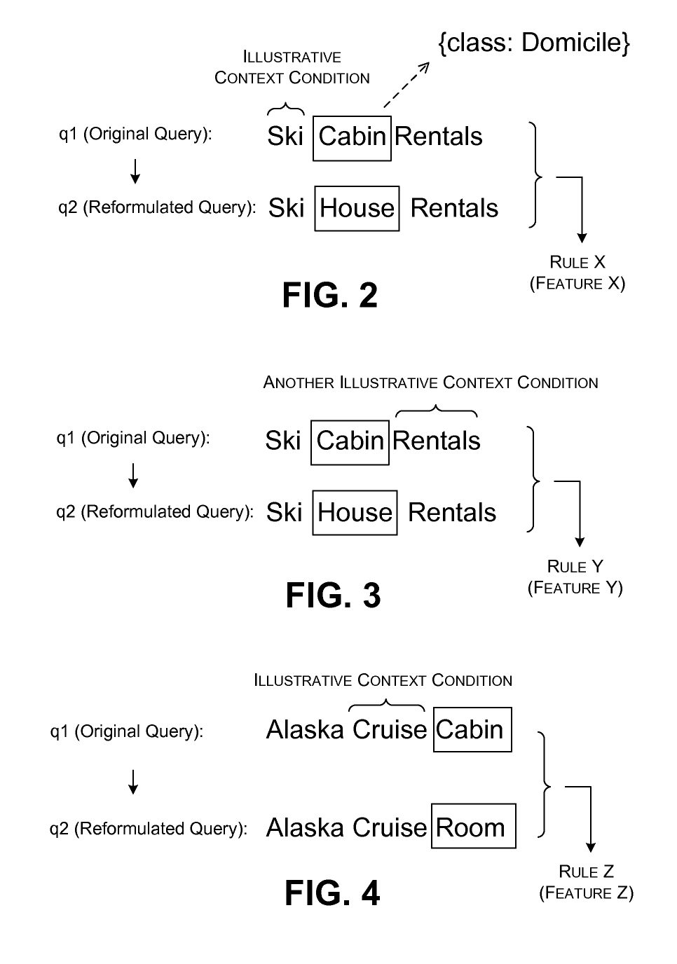

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative search engine, including a query alteration module for altering search queries to make them more relevant. Section A also describes a model generation module for using a machine learning technique to generate a model for use by the query alteration module. Section B describes illustrative methods which explain the operation of the search engine and model generation module of Section A. Section C describes illustrative processing functionality that can be used to implement any aspect of the features described in Sections A and B.

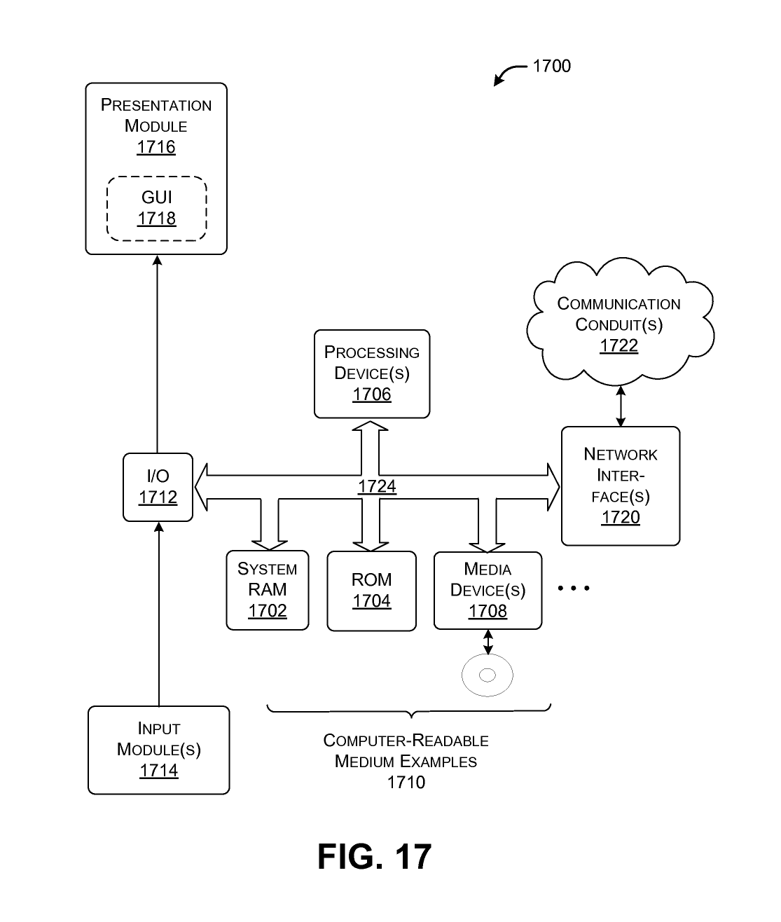

As a preliminary matter, some of the figures describe concepts in the context of one or more structural components, variously referred to as functionality, modules, features, elements, etc. The various components shown in the figures can be implemented in any manner by any physical and tangible mechanisms (for instance, by software, hardware, firmware, etc., and/or any combination thereof). In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 17, to be discussed in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms (for instance, by software, hardware, firmware, etc., and/or any combination thereof).

As to terminology, the phrase “configured to” encompasses any way that any kind of physical and tangible functionality can be constructed to perform an identified operation. The functionality can be configured to perform an operation using, for instance, software, hardware, firmware, etc., and/or any combination thereof.

The term “logic” encompasses any physical and tangible functionality for performing a task. For instance, each operation illustrated in the flowcharts corresponds to a logic component for performing that operation. An operation can be performed using, for instance, software, hardware, firmware, etc., and/or any combination thereof. When implemented by a computing system, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not expressly identified in the text. Similarly, the explanation may indicate that one or more features can be implemented in the plural (that is, by providing more than one of the features). This statement is not be interpreted as an exhaustive indication of features that can be duplicated. Finally, the terms “exemplary” or “illustrative” refer to one implementation among potentially many implementations.

A. Illustrative Search Engine and Model Generation Module

FIG. 1 shows an environment 100 which includes a search engine 102 together with a model generation module 104. At query time, the search engine 102 receives a search query from a user. In response, the search engine 102 identifies documents that may be relevant to the search query. To perform this task, the search engine 102 includes a query alteration module 106. If deemed appropriate, the query alteration module 106 transforms the search query into one or more alternative version of the search query, each referred to herein as a query alteration. Searching functionality 108 then uses the query alteration(s) to perform a search over a search index, e.g., as provided in one or more data stores 110. The searching functionality 108 can then provide the search results to the user. The search results may comprise a list of text snippets and resource identifiers (e.g., URLs) associated with the documents (e.g., web pages) that have been identified as relevant to search query. The purpose of the model generation module 104 is to use a machine learning technique to generate a model 112. The model 112, once installed in the search engine 102, enables the query alteration module 106 to transform the original search query into the query alteration.

In many of the examples presented herein, the search engine 102 may comprise functionality for searching a distributed repository of resources that can be accessed via a network, such as the Internet. However, the term search engine encompasses any functionality for retrieving structured or unstructured information in any context from any source or sources. For example, the search engine 102 may comprise retrieval functionality for retrieving information from an unstructured database.

The above-summarized components of the environment 100 will be explained below in turn. To begin with, FIG. 1 indicates that the model generation module 104 generates the model 112 based on training information which may be stored in one or more data stores 114. For example, the data store(s) 114 may represent a web log. The training information may include user behavior information. The user behavior information, in turn, includes at least two components: query reformulation information and preference information. The query reformulation information identifies queries reformulations made by at least one agent in an effort to retrieve relevant documents, such as query reformulations created by users, and/or query reformulations suggested by the query alternation module 106 itself (and subsequently selected by the users), etc. For example, a user may enter a first search query (q1), which prompts the search engine 102 to provide search results which identify a first set of items, such as documents. The user may or may not be satisfied with the search results produced by the first search query (q1). If not, the user may decide to manually modify the first search query (q1) in any manner to produce a second, reformulated, search query (q2). This prompts the search engine 102 to identify a second set of documents. The user may repeat this procedure any number of times until the user receives search results that satisfy his or her search objectives, or until the user abandons the search. Generally, the query formulation information describes the consecutive queries entered by users in the above-described iterative search behavior.

The preference information describes any behavior exhibited by users which has a bearing on whether or not the users are satisfied with the results of their respective search queries. For example, with respect to a particular reformulated query, the preference information may correspond to an indication of whether or not a user selected an item within the search results generated for that particular reformulated query, such as whether or not the user “clicked on” or otherwise selected at least one network-accessible resource (e.g., a web page) within the search results. In addition, or alternatively, the preference information can include other types of information, such as dwell time information, re-visitation pattern information, etc.

The above-described preference information can be categorized as implicit preference information. This information indirectly reflects a user's evaluation of the search results of a search query. In addition, or alternatively, the preference information can include explicit preference information. Explicit preference information conveys a user's explicit evaluation of the results of a search query, e.g., in the form of an explicit ranking score entered by the user or the like.

Based on the query formulation information and the preference information, the model generation module 104 generates labeled reformulation information. For each query reformulation, the labeled reformulation information provides a tag or the like which indicates the extent to which a user is satisfied with the query reformulation (in view of the particular search objective of the user at that time). In one case, such a tag can provide a binary good/bad assessment; in another case, the tag can provide a multi-class assessment. In the binary case, a query reformulation is good if it can be directly or indirectly assumed that a user considered it as satisfactory, e.g., based on click data conveyed by the preference information and/or other evidence. A query formulation is bad if it can be directly or indirectly assumed that a user considered it as unsatisfactory, e.g., based on the absence of click data and/or other evidence. The explanation below (with reference to FIG. 9) provides illustrative preference-mapping rules that can be used in one implementation to map the preference information to particular query reformulation labels for the binary case.

In the above case, the tags applied to query reformulations reflect individual assessments made by individual users (either implicitly or explicitly). In addition, or alternatively, the model generation module 104 can assign tags to query formulations based on the collective or aggregate behavior of a group of users. Further, the model generation module 104 can apply a single tag to a set of similar query reformulations, rather than to each individual query reformulation within that set.

The corpus of labeled reformulated queries comprises a training set used to generate the model. More specifically, the model generation module 104 uses the labeled reformulated information to generate the classification model 112, based on a machine learning technique. The model 112 thus produced comprises a plurality of features having respective weights associated therewith. Optionally, each feature may also have a level of uncertainty associated therewith. Optionally, the model 112 can also express pairwise uncertainty, that is, the amount that two features covary together, and/or uncertainty associated with any higher-order combination(s) of features (e.g., expressing three-way interaction or greater).

More specifically, each feature defines a rule for altering a search query in a defined manner at query time, assuming that the feature matches the search query. For example, for a feature to match the search query, the search query (and/or circumstance surrounding the submission of the search query) is expected to match a context condition (CC) specified by the feature. Once generated, the model 112 can be installed by the query alteration module 106 for use in processing search queries in normal production use of the search engine 102.

More specifically, at query time, assume that a user submits a new search query. The query alteration module 106 can use the model 112 to identify zero, one, or more candidate alterations that are appropriate for the search query. Namely, each candidate alteration matches at least one feature in a set of features specified by the model 112. If possible, the query alteration module 106 then generates at least one recommended alteration of the search query, selected from among the candidate alteration(s). This can be performed based on scores associated with the respective candidate alteration(s). The search engine 102 can then automatically pass the recommended alteration(s) to the searching functionality 108. Alternatively, or in addition, the search engine 102 can direct the recommended alteration(s) to the user for his or her consideration.

In one implementation, the query alteration module 106 includes a context-aware query alteration (CAQA) module 116 which performs the above-summarized functions. The CAQA module 116 is said to be “context aware” because it takes into account contextual information within (or otherwise applicable to) the search query in the course of modifying the search query. The CAQA module 116 can optionally work in conjunction with other (possibly pre-existing) alteration functionality 118 provided by the search engine 102. For example, the CAQA module 116 can perform high-end contextual modification of the search query, while the other alteration functionality 118 can perform more routine modification of the search query, such by providing spelling correction and routine stemming, etc. In another manner of combined use, the CAQA module 116 can perform a query alteration if it has suitable confidence that the alteration is valid. If not, the query alteration module 106 can rely on the other alteration functionality 118 to perform the alteration; this is because the other alteration functionality 118 may have access to more robust and/or dependable data compared to the CAQA module 116. Or the CAQA module 116 can refrain from applying or suggesting any query alterations.

FIGS. 2-5 provide a simplified example which clarifies the above-summarized principles. Starting with FIG. 2, assume that a user inputs a first search query (q1), “Ski Cabin Rentals,” with the objective of retrieving documents relevant to cabins that can be rented for an upcoming ski vacation. Assume, however, that the user is unsatisfied with the list of documents returned by the search engine 102 in response to the first search query (q1). To address this situation, assume that the user decides to modify the first search query (q1) by changing the word “Cabin” to “House.” This produces a second search query (q2), namely, “Ski House Rental,” which, in turn, produces a second list of documents. Assume that the user is now satisfied with at least one document in the second list of documents, e.g., as evidenced by the fact that the user clicks on this document in the list of search results or otherwise performs some behavior that evinces an interest in this document.

As to terminology, each component in a search query is referred herein as a query component or query entity. For example, the first search query (q1) includes the query components “Ski,” “Cabin,” and “Rentals.” Here, the sequence of query components corresponds to a sequence of words input by the user in formulating the search query. Any query component can alternatively refer to information which is related to or derived from one or more original words in a search query. For example, the search engine 102 can consult any type of ontology to identify a class (or other entity) that corresponds to an original word in a search query. That entity can be subsequently added to the search query, e.g., to supplement the original words in the search query and/or to replace one or more original words in the search query. One illustrative ontology that can be used for this purpose is the YAGO ontology described in, for example, Suchanek, et al., “YAGO: A Core of Semantic Knowledge Unifying WordNet and Wikipedia,” Proceedings of the 16th International Conference on World Wide Web, 2007, pp. 697-706. In the context of FIG. 1, this figure shows that the query alteration module 106 can utilize one or more alteration resources 120 in processing search queries, one of which may be any type of ontology. And FIG. 2 indicates the manner in which a word in the first search query (q1) (“cabin”) can be mapped, using an ontology, to a class (“domicile”). However, so as to not unduly complicate the following explanation, most of the examples will make the simplifying assumption that the query components correspond to original words in the search query.

There is a part of the first search query (q1) which is not common to the second search query (q2). This first part is referred to by the symbol 51. The first part (S1) can include a sequence of zero, one, or more query components. There is also a counterpart part of the second search query (q2) which is not common to the first search query (q1). This second part is referred to by the symbol S2. The second part (S2) can include a sequence of zero, one, or more query components. The transformation of the first part to the second part is referred to by the notation 514 S2. In the example of FIG. 2, the first part (S1) corresponds to the query component “Cabin” and second part (S2) corresponds to the query component “House.” In the examples that follow, to facilitate explanation, it will be assume that the modification of S1 to S2 involves the modification, introduction, or removal of a single query component, e.g., a word, class label, etc.

A context condition (CC) defines a context under which the first part (S1) is transformed into the second part (S2). More specifically, in one case, the context condition may include a combination of zero, one, or more context components (e.g., corresponding to zero, one, or more respective query components) that are expected to be present in the first query for the modification S1→S2 to take place. In the scenario of FIG. 1, the context condition corresponds to the single context component “Ski.” More generally, in the examples to follow, each context condition will correspond to a single query component. But, in the more general case, a context condition can include a combination of two or more context components, formally described as Λᵢcᵢ, where cᵢ refers to the ith context component and Λᵢ refers to any way of combining that component with other components, e.g., using an AND operator, OR operator, NOT operator, etc. A context condition that has zero context components indicates, in one interpretation, that the context condition may apply to every possible context.

In the above examples, the context condition refers to query components that are present in a search query. However, as will be described below, a context condition may more generally refer to a prevailing context in which the user submits the search query. The context condition of the search query may derive from information that is imparted from some source other than the search query itself.

The model generation module 104 can derive at least one feature based on the query reformulation described in FIG. 2. To repeat, each feature describes a rule for converting S1 to S2 under the presence of a context condition, or more formally expressed as (CC) S1→S2, where CC represents the context condition. In the case of FIG. 2, the feature states that the query component “Cabin” is transformed into the query component “House” in the presence of the context condition “Ski.” Less formally stated, the feature states that, when the word “Cabin” is used in the same query with the word “Ski,” it may mean that the user is attempting to describe a house that is nearby a ski slope, instead of using the word “Cabin” in a different sense, such as the nautical sense of FIG. 4.

In many cases, the model generation module 104 can generate a plurality of rules based on a single query reformulation. For example, FIG. 3 shows the same query formulation as FIG. 2. In this case, the model generation module 104 identifies the context condition “Rentals,” instead of the context condition “Ski.” This results in the generation of another feature based on this context condition. Another feature (not shown) may specify a context condition that identifies the length of S1 (e.g., the number of query components in S1), and so on.

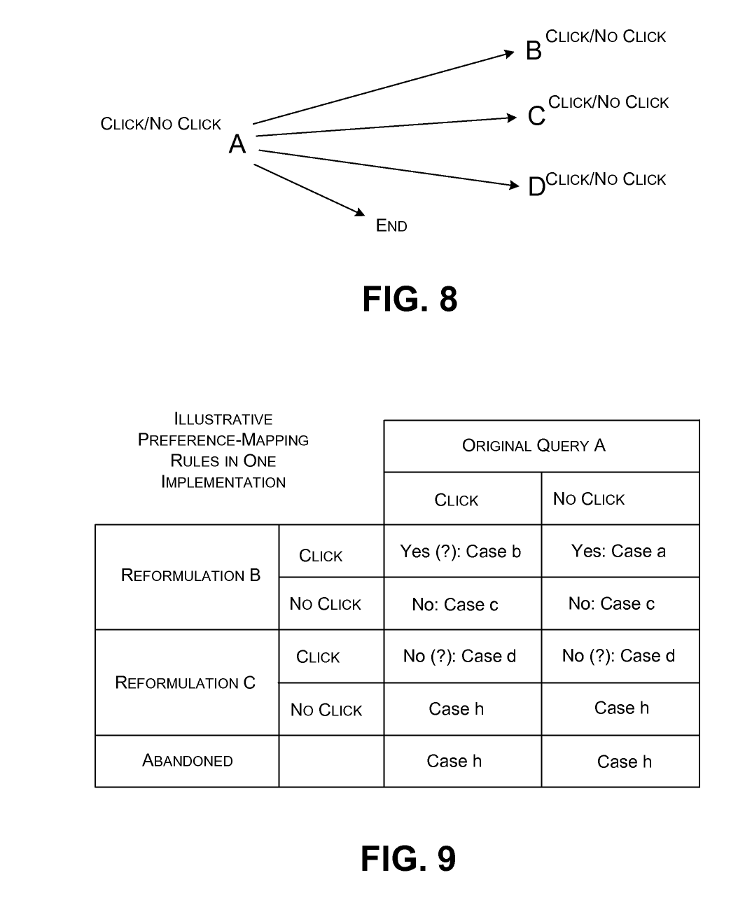

In general, when mining a query pair for features, the model generation module 104 can look for any context condition selected from a set of possible context conditions. FIG. 10, to be described below, describes one such set of possible context conditions. From a high level perspective, some of the context conditions depend on the mere presence of a context component (e.g., a query component) in the first search query (q1). Other of the context conditions depend on a particular location of a context component within the first search query (q1). In addition, or alternatively, some of the context conditions specify constraints that pertain to the length of the first search query (q1), e.g., relating to the number of query components in the first search query, and so on. And as noted above, other context conditions can pertain to information which derives from a source (or sources) that are beyond that of the immediate search query.

FIG. 4 shows another query formulation in which the user enters a first search query “Alaska Cruise Cabin.” Here, the user is apparently looking for information regarding the rooms of a cruise ship. If the user is unhappy with the results of the first search query, assume that the user enters a second search query, namely “Alaska Cruise Room.” The model generation module 104 learns a feature based on this reformulation that specifies that the query component “Cabin” is modifiable to the query component “Room” in the presence of the context condition “Cruise.” In other words, the word “Cruise” casts a different interpretation on the manner in which the word “Cabin” is to be modified, compared to the first example (of FIG. 2).

As can be appreciated, the model generation module 104 can generate an enormous number of features by processing query reformulations in the manner described above. In this process, the model generation module 104 can transform the search queries and their respective query reformulations into feature space. This space represents each query using one or more features, as described above. The features associated with queries may be viewed as statements that characterize those queries, where those statements that can be subsequently processed by a machine learning technique.

However, many of the features in feature space are encountered only once or only a few times, and thus do not provide general rules to guide the operation of the CAQA module 116 at query time. To identify meaningful features, the model generation module 104 generates parameter information. For example, the parameter information can include weights assigned to each feature. Generally speaking, a weight relates to a number of instances of a feature which have been encountered in a corpus of query reformulations. The parameter information can also optionally include uncertainty information (such as variance information) which reflects the level of uncertainty associated with each individual feature, e.g., each weight. As stated above, the uncertainty information can also express joint uncertainty, that is, the amount that two features covary together, and/or uncertainty associated with higher-order combinations.

For example, a feature that is observed many times and is consistently regarded as satisfactory by a user will have a high weight and a low level uncertainty. This feature is therefore a meaningful feature for inclusion in the model 112. A feature which is observed many times but has an inconsistent interpretation (as good or bad) may have a relatively high weight but a higher level of uncertainty (compared to the first case). A feature which is seldom encountered may have a low weight and a high level of uncertainty. As will be described in greater detail below, in one implementation, the model generation module 104 may bias the interpretation of weights in a conservative manner, e.g., by diminishing a feature's weight in proportion to its level of uncertainty. Further, to expedite and simplify subsequent query-time processing, the model generating module 104 can remove features that have weights and/or levels of uncertainties that do not satisfy prescribed threshold(s).

Assume that a model 112 is produced based on a corpus of training information, a small part of which is shown in FIGS. 2-3. Then assume that the model 112 is installed in the CAQA module 116. At query time, the CAQA module 116 applies the model 112 when processing new search queries. FIG. 5 shows one such illustrative search query. Here, the user inputs “Caribbean Cruise Cabin,” with the apparent intent of investigating information regarding rooms on a cruise ship that sails the Caribbean Sea. In operation, the CAQA module 116 first matches the search query against a set of possible features specified in the model 112. The search query matches a feature when it includes a part S1 and a context condition that are specified by the feature. If there is a match, the matching feature supplies the part S2 of the feature. Each matching feature has a weight, and, optionally, an uncertainty associated therewith. Any combinations of features (such as pairs of features, etc.) may also have uncertainty associated therewith.

By identifying a matching feature, the CAQA module 116 also generates a counterpart candidate alteration of the search query (“Caribbean Cruise Cabin”). In some cases, a single query candidate alteration may be predicated on two or more underlying matching features. The CAQA module 116 also assigns a score to each candidate alteration based on the weight(s) (and optionally uncertainty(ies)) associated with the candidate alteration's underlying matching feature(s).

The CAQA module 116 can then select one or more of the candidate alterations based on the scores associated therewith. According to the terminology used herein, this operation produces one or more recommended alterations. The top-ranked recommended alteration shown in FIG. 5 is “Caribbean Cruise (Cabin or Room).” For this entry, it is apparent that the CAQA module 116 has applied the rule learned in FIG. 4, rather than the two rules learned in FIGS. 2 and 3. This is an appropriate outcome because the user is using the word “Cabin” in the context of a room on a ship, not a house on land. The search engine 102 may then proceed to pass the altered search query (“Caribbean Cruise (Cabin or Room)”) to the searching functionality 108. In some cases, the search engine 102 can pass two or more recommended alterations to the searching functionality 108, both of which are used to generate search results. Or the search engine 102 may just suggest one or more query alterations to the user.

In the above simplified example, the model 112 was learned on the basis of a context condition expressed in each search query q1 of each pair of consecutive search queries (q1, q2). And in the real-time search phase, the CAQA module 116 examines the context condition expressed in the current search query q1. In other cases, the context condition can be derived from any other source (or sources) besides, or in addition to, the user's search query q1. For example, the context condition that is deemed to apply to a particular search query q1 can originate from any other search query in the user's current search session, and/or any group of search queries in the current search session, and/or any search query(ies) over plural of the user's search sessions. In addition, or alternatively, a context condition can derive from text that appears in text snippets that appear in the search results, etc. In addition, or alternatively, the context condition can derive from any type of user profile information (associated with the person who is currently performing the search). In addition, or alternatively, the context condition can derive from any behavior of the user beyond the reformulation behavior of the user, and so on. These variations are representative, rather than exhaustive. Generally stated, the context condition refers to any circumstance in which a transformation from S1→S2 has been observed to take place, derivable from any source(s) of evidence. This, in turn, means that the features themselves are derivable from any combination of sources. However, to facilitate the explanation, the remaining description will assume that the features are mined from pairs of consecutive queries.

In addition, the CAQA module 116 can create a query alteration by applying two or more features in succession to an input search query q1. However, to facilitate the explanation, the remaining description will assume that the CAQA module 116 applies a single feature having a single transformation S1→S2.

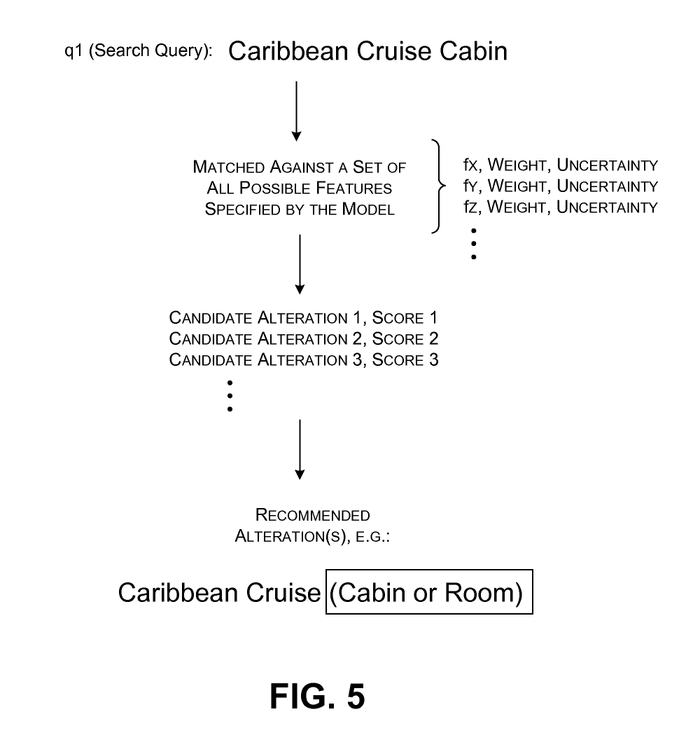

FIG. 6 depicts one illustrative implementation 600 of the environment 100 shown in FIG. 1. In this example, a user interacts with local computing functionality 602 to input search queries and receive search results. The local computing functionality 602 can be implemented by any computing functionality, including a personal computer, a computer workstation, a laptop computer, a PAD-type computer device, a game console device, a set-top box device, a personal digital assistant device, and electronic book reader device, a mobile telephone device, and so on.

The local computing functionality 602 is coupled to remote computing functionality 604 via one or more communication conduits 606. The remote computing functionality 604 can be implemented by one or more server computers in conjunction with one or more data stores, routers, etc. This equipment can be provided at a single site or distributed over plural sites. The communication conduit(s) 606 can be implemented by one or more local area networks (LANs), one or more wide area networks (WANs) (e.g., the Internet), one or more point-to-point connections, and so on, or any combination thereof. The communication conduits(s) 606 can include any combination of hardwired links, wireless links, name servers, routers, gateways, etc., governed by any protocol or combination of protocols.

In one implementation, the remote computing functionality 604 implements both the search engine 102 and the model generation module 104. Namely, the remote computing functionality 604 can provide these components at the same site or at different respective sites. A user may operate browser functionality 608 provided by the local computing functionality 602 in order to interact with the search engine 102. However, this implementation is one among many. In another case, the local computing functionality 602 can implement at least some aspects of the search engine 102 and/or the model generation module 104. In another implementation, the local computing functionality 602 can implement all aspects of the search engine 102 and/or the model generation module 104, potentially dispensing with the use of the remote computing functionality 604.

Having now set forth an overview of the environment 100 shown in FIG. 1, the remaining explanation in this section will set forth additional details regarding individual components within the environment 100.

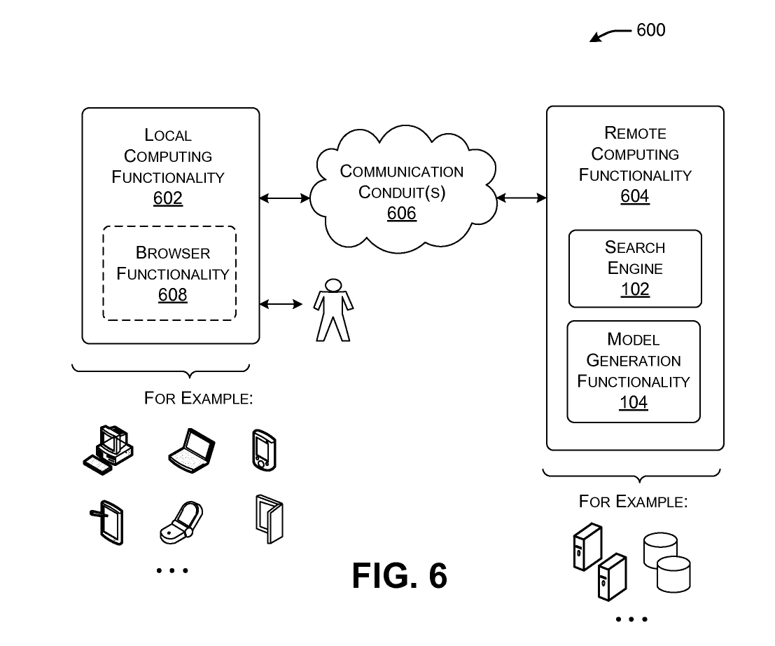

Starting with FIG. 7, this figure shows additional details regarding the model generation module 104 of FIG. 1. The model generation module 104 includes a label application module 702 which receives the query reformulation information and the preference information from a web log (associated with the data store(s) 114 shown in FIG. 1), optionally as well as other training information. To repeat, the query reformulation information describes a plurality of query reformulations made by at least one agent, such as users. The preference information reflects behavior that can be mined to infer an extent to which the users were satisfied (or not) with their query formulations.

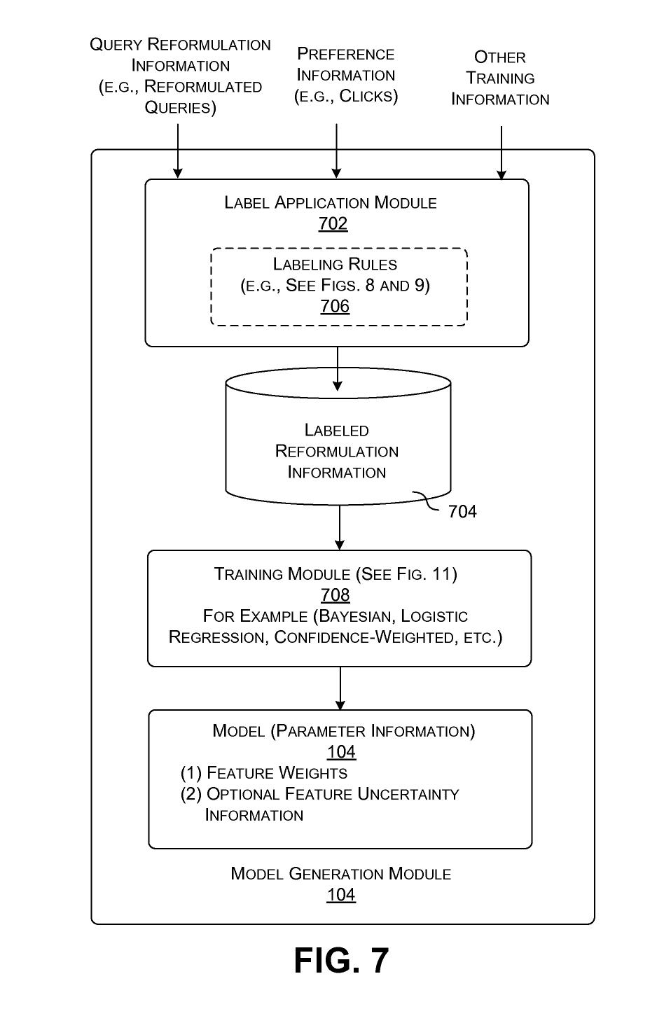

The label application module 702 uses the query reformulation information and preference information to assign labels, either individually or in some aggregate form, to the reformulated queries, forming labeled reformulation information, which can be stored in one or more data stores 704. For example, in the binary case, the label application module 702 can assign a first label (e.g., +1) that indicates that the user was satisfied with a query reformulation, and a second label (e.g., −1) that indicates that the user was dissatisfied with the query reformulation. To function as described, the label application module 702 can rely on a set of labeling rules 706. One implementation of the labeling rules 706 will be set forth in the context of FIGS. 8 and 9 (below).

A training module 708 uses a machine learning technique to produce the model 112 based on the labeled reformulation information. The training process generally involves identifying respective pairs (or other combinations) of queries, identifying features which match the pairs of queries, and generating parameter information pertaining to the features that have been identified. This effectively converts the queries into a feature-space representation of the queries. The parameter information can express weights associated with the features, as well as (optionally) the levels of uncertainty (e.g., individual and/or joint) associated with the features. More specifically, the training module 708 can use different techniques to produce the model 112, including, but not limited, to a Naïve Bayes technique, a logistic regression technique, a confidence-weighted technique, and so on. Section B provides additional details regarding these techniques.

In the binary case, FIGS. 8 and 9 together set forth one approach that can be used to label query reformulations as satisfactory or unsatisfactory based on click data. In one implementation, the click data reflects network-related resources (e.g., web pages) that the users clicked on immediately after submitting queries and receiving associated search results. As explained above, other implementations can mine other facets of user behavior to determine the users' likes and dislikes.

Starting with FIG. 8, assume that the user first enters search query A. Some of the users then reformulate query A as query B. Other users reformulate the query A as query C. Other users reformulate the query A as query D, and so on. Still other users abandon the search altogether after entering query A. At any juncture, the user may either click on at least one entry in the search results (“Click”) or not click on any entries in the search results (“No Click”).

According to the terminology used herein, the number of users who are given the opportunity to click on any entry in the search results generated by a search query X is denoted as I_{X} (e.g., indicating the number of impressions for that query X). The number of users who actually clicked on an entry for query X is denoted as C_{X}. The number of users who are given the opportunity to click on any entry for query Y after entering query X is denoted as I_{Y|X}. The number of users who actually clicked on any entry in this X→Y circumstance is denoted by C_{Y|X}.

FIG. 9 sets forth illustrative preference-mapping rules that can be used to interpret the behavior shown in FIG. 8. In particular, this table is aimed at determining whether the user is satisfied with query B, which is a reformulation of query A. First consider the relatively clear-cut case in which the user performs the query reformulation A→B and then clicks on an entry in the results for query B, but not on an entry for query A. For this case (“case a”), it can be assumed that the user is satisfied with the query B.

Next consider the case in which the user performs the reformulation A→B, but clicks on entries in the results for both queries A and B, corresponding to “case b.” A portion of these users may like query B and a portion may dislike query B. For this case, a parameter α can be used to indicate the percentage of people who clicked on the results for query B and actually liked query B.

Next, again consider the case in which a user performs the reformation A→B, but this time does not click on an entry for result B. For this case (“case c”), it can be assumed that the user does not like query B, whether or not the user also clicked on an entry for query A.

Next consider the case of users who did not perform the alteration A→B. Among them, the users who did not click on any entries for any results can be ignored (corresponding to “case h”), as this behavior does not have any apparent bearing on whether the users liked or disliked query B. Other users may have clicked on entries for certain queries, as in the case for users who clicked on entries for query C. For this case (“case d”), it can be assumed that all of the users found what they were looking for and therefore would dislike query B. But this may be overly pessimistic because query B may be equally as good as query C or better. For this case (“case d”), a parameter β can be used to indicate the percentage of people who clicked on the results for query C (or some other query) and would dislike query B.

In summary, the number of users who vote for the A→B reformulation can be expressed as a+αb. The number of users who vote against the A→B reformulation can be expressed as c+βd. The parameters (α, β) control the preference interpretations in the ambiguous scenarios described above, and can be set to the default values of α=1 and β=0.

In addition to the above considerations, the users' click behavior may include noise. In other words, the users had certain search objectives when they submitted their search queries. The users' click behavior may contain instances in which the users' clicks are not related to satisfying those search objectives, and can thereby be considered tangential to those search objectives. The label application module 702 (of FIG. 7) can also perform operations to account for these inadvertent instances.

For example, consider a first situation in which a user clicks on an entry for query X. In the great majority of the cases, this means that the user likes query X. Alternatively, the user may have clicked on this entry by accident, or the user may have clicked on this entry for some tangential reason that is unrelated to his or her original search objective, or the user may have clicked on this entry to then discover that the entry is not actually related to satisfying his or her original search objective, etc. To address this situation, the label application module 702 can generate a corrected number of clicks for query X as C_{X}=max(0, C_{X}−(I_{X}*1%)). This expression means that the number of impressions for query X is multiplied by some corrective percentage (e.g., 1% in this merely representative case). That result is subtracted from the uncorrected number of clicks (C_{X}) to provide the corrected number of clicks (unless the result is negative, upon which the number of clicks is set to 0).

Consider a second situation in which a user switches from query A to query B. In many cases, this behavior indicates that the user thinks that query B is a good reformulation of query A. But in other cases, the user may simply wish to switch to another topic (where query B would reflect that new topic). Or this click may be accidental, or unsatisfying, etc. To address this situation, the label application module 702 can define, for each query pair A→B, the corrected number of impressions I_{A|B} as max(0, I_{A|B}−α_{B}I_{A}), and the corrected number of clicks C_{A|B}=max(0, C_{A|B}−γ_{B}α_{B}I_{A}). In this expression, α_{B}=I_{B}/Iₜₒₜ, where Iₜₒₜ refers to the total impression count, and γ_{B}=C_{B}/I_{B}.

The above-described noise-correction provisions are environment-specific. Other environments and applications may use other algorithms and parameter settings for identifying and correcting the presence of noise in the preference information.

Advancing to FIG. 10, this figure shows a set of seven illustrative context conditions that can be used to define features for inclusion in the model 112. In each case, the context condition identifies a context in which a transformation (S1→S2) takes place, involving changing a part (S1) in a first query (q1) to another part (S2) in a second query (q2). To repeat, the part S1 can include zero, one, or more query components. Likewise, the part S2 can include zero, one, or more query components. The context conditions described here originate from the first search query q1, but, as stated above, they can originate from any combination of sources.

A first context condition specifies that a specific context component w (e.g., a word, a class, etc.) occurs anywhere in the search query q1. This may be referred to as a non-structured or simple word context condition. A second context condition specifies that a specific context component w appears immediately before S1 in q1. FIG. 2 is an example of this type of context condition. A third context condition specifies that a specific context component w occurs immediately after S1 in q1. FIG. 3 is an example of this type of context condition. For the first through third context conditions, q1 can be arbitrarily long. Further, the second and third context conditions may be referred to as structured word context conditions because they have some bearing on the local structure of q1.

A fourth context condition specifies a length of S1 (or a length of q1), e.g., as having one, two, three, etc. query components. A fifth context condition specifies that q1 consists of only S1. A sixth context condition specifies that q1 consists of only a single context component w followed by S1. And a seventh context condition specifies that q1 consists of only S1 followed by a single context component w. The fourth through seventh context conditions define overall-structure context conditions, e.g., because these context conditions have some bearing on the overall structure (e.g., length) of the search query q1. Further, the fourth through seventh context conditions can be referred to as non-lexicalized context conditions because they apply without reference to a specific context component (e.g., a specific word or class). For example, the sixth context condition is considered to be met for any context component w followed by S1. In contrast, the first through third context conditions can be referred to as lexicalized context conditions because they apply to particular context components (e.g., specific words or classes).

More generally, the above-described set of possible context condition is environment-specific. Other environments and applications may use other sets of context conditions, e.g., by specifying any type of structural information regarding the search queries of any complexity, such as N-gram information in the search queries, etc.

The model generation module 104 constructs features with context conditions selected from the set of possible context conditions shown in FIG. 10 (which can be expanded at any time to encompass more context conditions). More specifically, the model generation module 104 can construct different types of features. A lexicalized feature corresponds to any feature which involves the replacement of a part S1 with a part S2, wherein that modification is learned on the basis of at least one query pair in a corpus of query reformulations. A lexicalized feature can be expressed as (CC) S1→S2. A lexicalized feature expressly specifies both the parts S1 and S2.

In a template feature, the parts S1 and S2 are related by some transformation operation ε, e.g., ε(S1)=S2. The operation E can be selected from a family of transformations, such as stemming, selection of an antonym from an antonym source, selection of a redirection entry from a redirection source (such as the Wikipedia online encyclopedia), and so on. In one application, template alterations can be used for cases in which a word has not been seen in the training information (e.g., query reformulations) but can still be handled by, for example, a stemming algorithm that attempts to convert a singular form of the word to a plural form, etc. The model generation module 104 can determine whether a template transformation E is present in a pair of queries (q1, q2) by determining whether these queries contain parts S1 and S2 that can be related by ε(S1)=S2. A template feature not need expressly specify S2, since S2 is derivable from S1.

In certain implementations, the model generation module 104 can define various constraints on the construction of features. For example, as stated above, some environments may be limited to context conditions that contain only one context component. In another case, if S1 has zero query components, then the context condition is constrained to contain one of the structured word context conditions shown in FIG. 10 (e.g., as specified by context conditions 2 or 3). In another case, a template alteration is combinable only with one of the structured word contexts (e.g., wε, εw, as specified in context conditions 2 or 3 in FIG. 10), or a constraint on a word class of S1 (e.g., ε(w)),), etc.

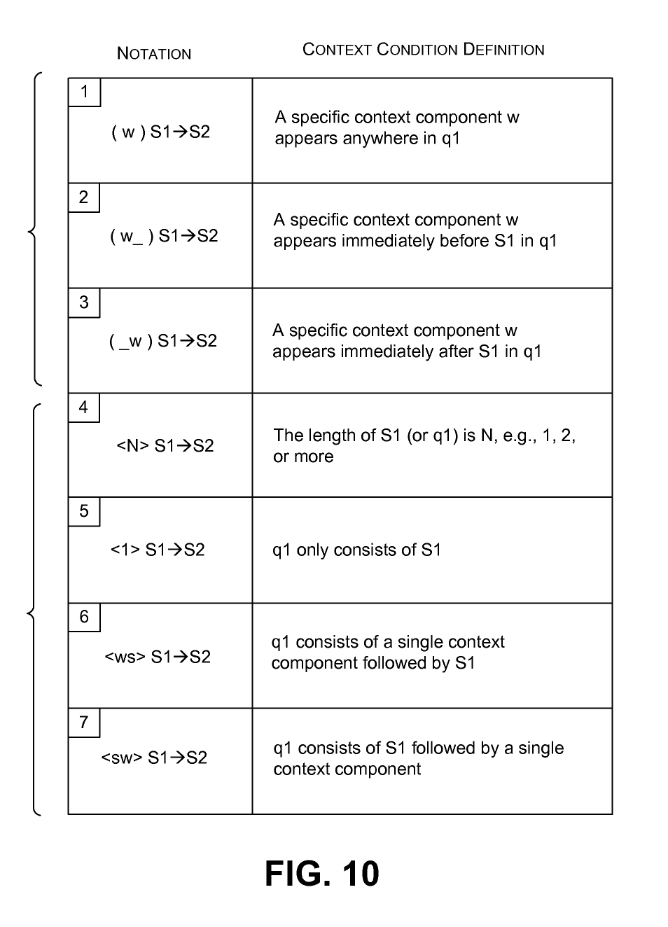

Advancing to FIG. 11, this figure provides additional details regarding the training module 708 introduced in FIG. 7. The training module 708 includes a feature matching module 1102 for identifying features that are present in a corpus of, for example, reformulated query pairs (q1, q2) (or other query combinations). To perform this function, the feature matching module 1102 draws from matching criteria 1104. The matching criteria 1104 informs the feature matching module 1102 what patterns to look for in the query pairs. This implementation is representative, not exhaustive; as stated above, the training module 708 can also draw from other sources in determining whether a particular search query in question satisfies a context condition.

For example, the feature matching module 1102 can identify a feature having a structured word context (such as context conditions 2 or 3 in FIG. 10) by performing matching against a pair of sequences, e.g., (wS1, S2) or (S1w, S2). The feature matching module 1102 can identify a feature having a simple word context (such as context condition 1 in FIG. 10) by matching against a tuple, e.g., (w, S1, S2). The feature matching module 1102 can identify a feature having a structure context (such as any context conditions 4, 5, 6, or 7 in FIG. 10) by matching against a tuple, e.g., (structured context, S1, S2). The feature matching module 1102 can identify a feature with a template alteration (e.g., wε, εw, ε(w), etc.) by matching against a tuple, e.g., (w, ε), (ε, w), (εw), etc.

A parameter information generation module 1106 can generate weights and (optionally) levels of uncertainty associated with the features (or combinations of features) identified by the feature matching module 1102. The parameter information generation module 1106 can use different techniques to perform this task depending on the type of model that is being constructed, as will be clarified in Section B. From a high level perspective, however, for the case of individual features, the weights reflect the prevalence of the detected features in the corpus of labeled query pairs. The levels of uncertainty reflect the consistency at which the features have been detected by the feature matching module 1102.

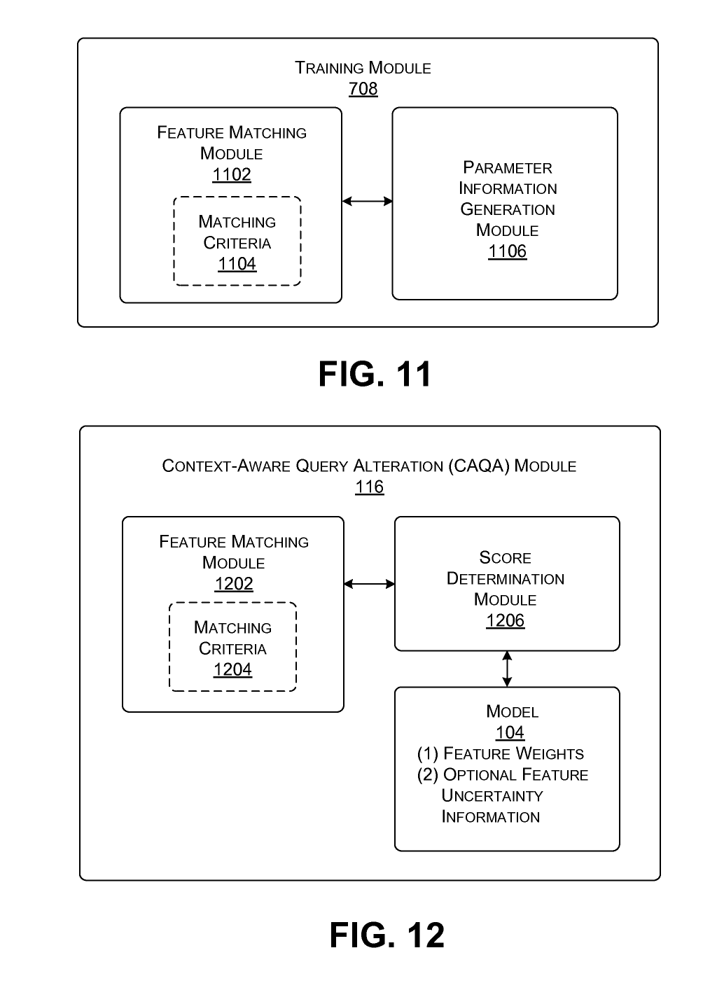

FIG. 12 shows additional details regarding the CAQA module 116 introduced in FIG. 1. The CAQA module 116 includes a feature matching module 1202 which performs a role that is similar to the feature matching module 1102 (used by the training module 708). Namely, at query time, the feature matching module 1202 examines a search query q1 to determine whether it matches one or more features, as defined by the matching criteria 1204. But here, the feature matching module 1202 determines whether the search query q1 includes (or is otherwise associated with) at least one context condition and at least one part S1 that matches at least one feature; the part S2 of any matching feature is supplied by the matching process itself, e.g., as explicitly defined by the matching feature or as defined by a template transformation E. As explained above, this process of identifying matching features also identifies candidate alterations. This is because a feature defines a manner of transforming the part S1 in the search query q1 into a part S2 in the alteration query q2 (to be generated).

A score determination module 1206 assigns a score to each candidate alteration defined by the feature matching module 1202. The score determination module 1206 can use different techniques to compute this score, depending on the type of model that is being used to express the features. Generally speaking, in one implementation, each candidate alteration may be associated with one or more features. And each feature is associated with a weight and (optionally) a level of uncertainty. The score determination module 1206 can generate the score for a candidate alteration by aggregating the individual weight(s) associated therewith, optionally taking into consideration the levels of uncertainty associated with the weight(s).

The score determination module 1206 can rank the candidate alterations based on their scores and select one or more highest-ranking alterations, referred to as recommended alterations herein. In some cases, the score determination module 1206 can take a conservative approach by discounting a weight by all or some of the level of uncertainty associated with the weight. This may bias the score determination module 1206 away from selecting any candidate alteration that is based on features (or combinations of features) having high levels of uncertainty.

B. Illustrative Processes

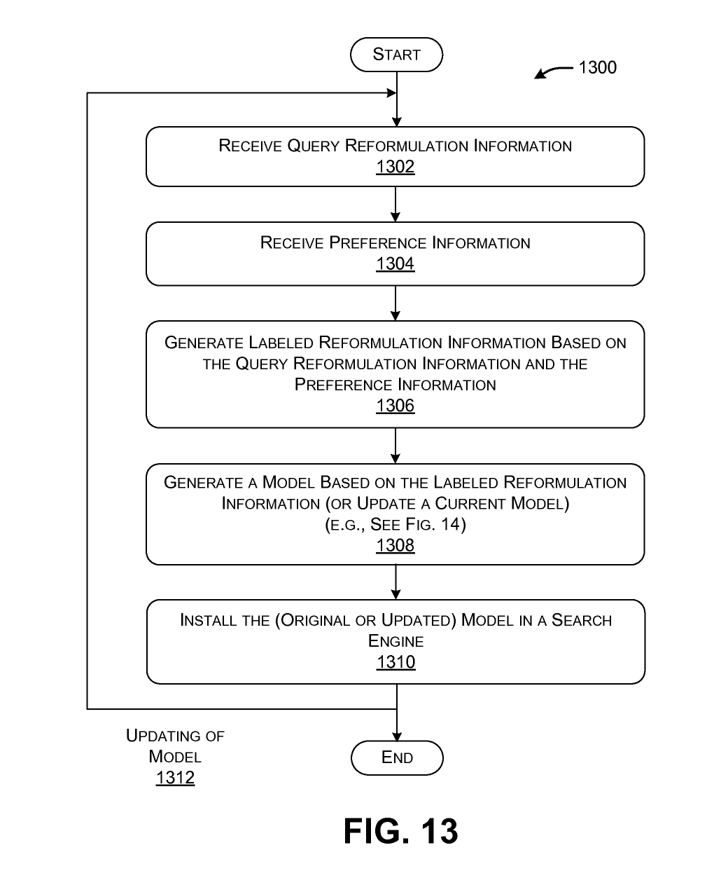

FIGS. 13-16 show procedures that explain the operation of the environment 100 of FIG. 1 in flowchart form. Since the principles underlying the operation of the environment 100 have already been described in Section A, certain operations will be addressed in summary fashion in this section.

Starting with FIG. 13, this figure shows a procedure 1300 that explains one manner of operation of the model generation module 104 of FIG. 1. In block 1302, the model generation module 104 receives query reformulation information that identifies query reformulations obtained from users and/or any other source. In block 1304, the model generation module 104 receives preference information. The preference information provides data that can be mined to determine the extent to which the users liked (or disliked) the reformulated queries. In block 1306, the model generation module 104 generates labeled reformulation information based on the query reformulation information and the preference information. Namely, that process may involve assigning binary or multi-class tags to the reformulated queries based on the preference information. In block 1308, the model generation module 104 uses a machine learning technique to generate a model 112 based on the labeled reformulation information created in block 1306. Block 1310 entails installing the created model 112 in the search engine 102, where it henceforth governs the operation of the CAQA module 116.

As shown in block 1312, the process depicted in FIG. 13 can be used to update a previously-created model that is being used by the search engine 102. In this case, the environment 100 shown in FIG. 1 can continuously or periodically collect new user behavior information (e.g., from a web log) and continuously or periodically update the model 112 to account for this new behavior information.

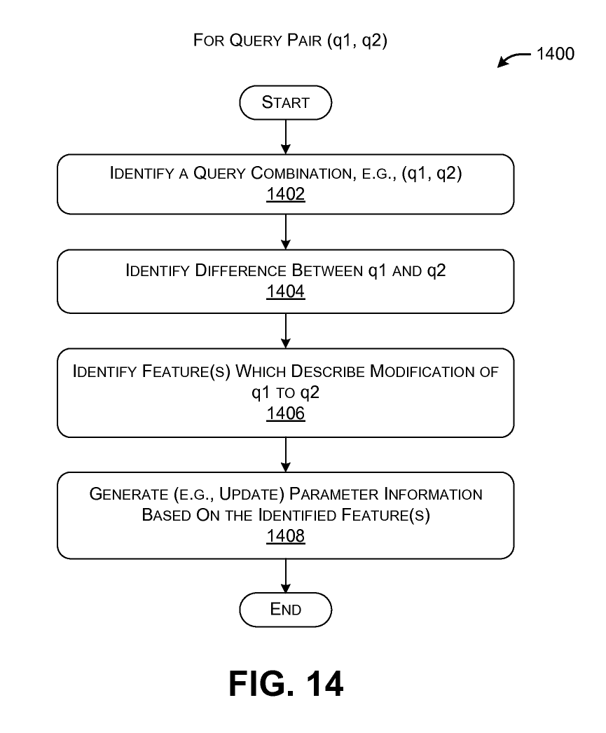

FIG. 14 shows a procedure 1400 which clarifies one manner of performing the model-generating operation of block 1308 of FIG. 13. This process is explained with respect to operations performed on a representative query pair (q1, q2), although, as described in Section A, this process can be performed based on other sources of training information. In block 1402, the model generation module 104 identifies the query pair (q1, q2). In block 1404, the model generation module 104 identifies the difference between q1 and q2, which generates the S1 and S2 parts described in Section A. This process may involve tokenizing each of the queries (q1, q2) by white spaces to identify their constituent query components (e.g., words). The process may then involve removing any common prefix and any common postfix shared by queries (q1, q2). In block 1406, the model generation module 104 identifies one or more features which describe the modification of S1→S2 in the presence of a one or more context conditions. More specifically, block 1306 describes the operations set forth above in the context of FIG. 11. In block 1408, the model generation module 104 generates (or updates) parameter information based on the feature detected in block 1406.

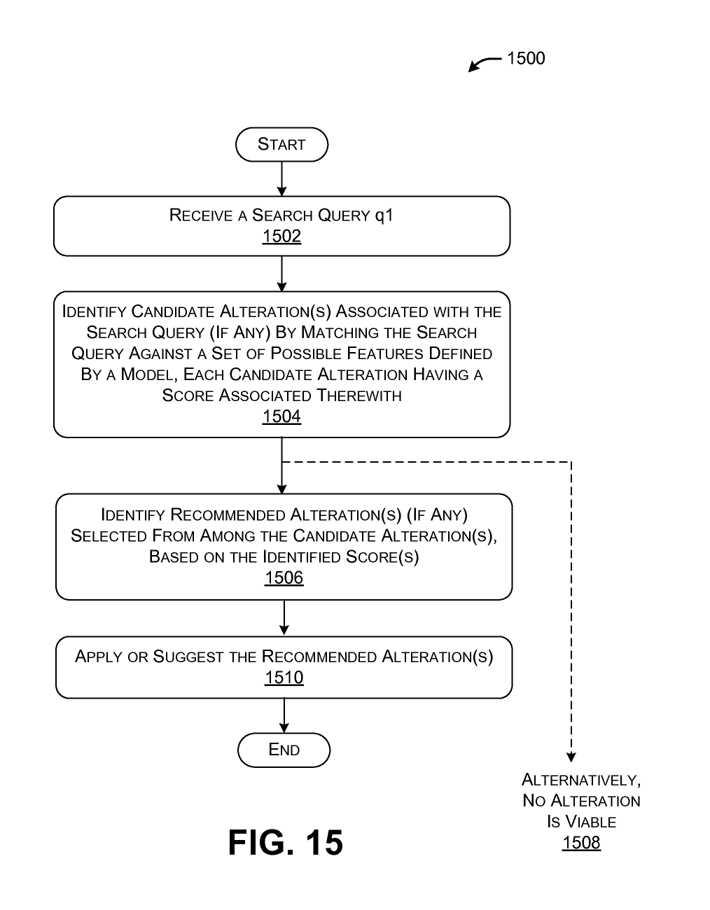

FIG. 15 describes a procedure 1500 which explains the query-time operation of the environment 100, e.g., in which the search engine 102 receives a new search query and generates (if appropriate) one or more query alterations based on this search query. In block 1502, the search engine 102 receives the search query. In block 1504, the search engine 102 uses the model 112 to identify one or more candidate alterations that can be used to modify the search query. This operation corresponds to the details provided above with respect to FIG. 12. In block 1506, the search engine 102 selects one or more candidate alterations that have been identified in block 1504, e.g., based on scores associated with the candidate alterations. Alternatively, none of the candidate alterations may be strong candidates, e.g., because their features have low weights and/or because they have high levels of uncertainty associated therewith. If so, in block 1508, the search engine 102 may decline to perform any alteration of the original search query. In block 1510, assuming that at least one viable recommended alteration has been identified, the search engine 102 can automatically forward the recommended alteration(s) to the searching functionality 108. Alternatively, or in addition, the search engine 102 can present the recommended alteration(s) to the user and invite the user to select one of these alterations. At least one of the recommended alterations may correspond to the original search query, if, in fact, no alteration is recommended as one option.

Aspects of the operations described in FIGS. 13-16 can be implemented in the context of different model-generation frameworks, such as a Naïve Bayes framework, a logistic regression framework, a confidence-weighted classification framework, and so on. The remaining part of this section provides additional details on various environment-specific implementations of the principles described above. These examples are representative, not exhaustive or limiting.

Consider first a Naïve Bayes approach. In this framework, the model generation module 104 can generate weights based on two probabilities. The first probability is the probability that a feature f is matched and an alteration is considered good, or P(f is matched|an alteration is good)=N_{f+}/N₊. The second probability is the probability that a feature f is matched and an alteration is considered bad, or P(f is matched|an alteration is bad)=N_{f-}/N₋. Here, N_{f+} (N_{f-}) is the number of times f has been matched in reformulated queries that are considered good (bad, respectively). N₊ (N₋) corresponds to the total number of good (bad, respectively) reformulations.

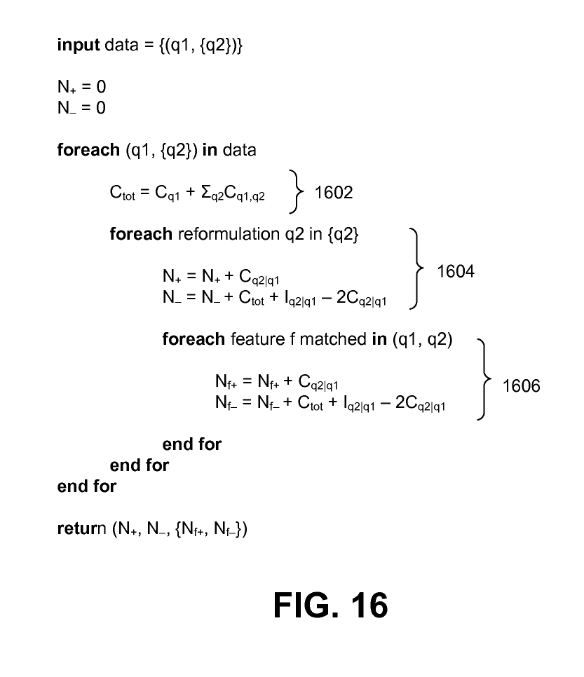

FIG. 16 shows one illustrative routine for generating the above-stated parameter information, e.g., N₊, N₋, {N_{f+}, N_{f-}}. In section 1602 of the routine shown in FIG. 16, the model generation module 104 computes an indication of a total number of clicks Cₜₒₜ. In section 1604, the model generation module 104 computes N₊ and N₋ for each query q2 in a set of q2's ({q2}) that can be paired with a query q1. In section 1606, the model generation module 104 computes N_{f+} and N_{f-} for each feature f matched in a query pair (q1, q2). As shown in FIG. 16, N_{f+}, is formed by determining the number of times users clicked on q2 after issuing q1. For N_{f-}, q2 is considered a bad alteration under two conditions. Either (a) a user clicks on q1 but never issues q2 (e.g., because the user is presumably satisfied with q1 alone), or (b) the user issues q2, but does not click on any results for q2. Thus, the total number of bad alterations is a sum with two parts: (a) Cₜₒₜ−C_{q2q1} (which is all the clicks for q1 that are left from the total after the clicks from q2 are subtracted), and (b) the total of all q2 results that were not clicked, i.e. I_{q2q1}−C_{q2q1}. This yields the factor of −2C_{q2q1} in FIG. 16.

In the query-time phase, a Naïve Bayes model uses a Bayesian rule to model P(y|x), where x is an input sample represented as a vector of features, and y is a class label of this sample. That is:

$$P ( y \vert x ) = \frac{P ( x \vert y ) P ( y )}{P ( x )} .$$

For a two-class classification problem, the probability can be expressed using P(Y=1|x)=σ (result(x)), where σ is the logit function σ(t)=1/(1+e^{-t}), and result(x) is defined as:

$$\begin{matrix}result ( x ) = log \frac{P ( Y = 1 , x )}{P ( Y = 0 , x )} \\ = log \frac{P ( Y = 1 )}{P ( Y = 0 )} + {\sum }_{i} {x}_{i} log \frac{P ( {X}_{i} = 1 \vert Y = 1 )}{P ( {X}_{i} = 1 \vert Y = 0 )} \\ = b + {\sum }_{i} {x}_{i} {w}_{i} .\end{matrix}$$

In the context of the present application, the vector x corresponds to a particular candidate alteration having a plurality of features (xᵢ) associated therewith and a plurality of corresponding weights (wᵢ). To reduce the complexity of these computations, the model generation module 104 can retain only a prescribed number of the most highest-weighted features, removing the remainder. In another application, the analysis described above can be used to assess the risk of altering a query. Here, the vector x can represents the query per se (where no translation rules are applied). In this case, the term weights represent the risk of altering different terms in the query to anything else.

Consider next the case in which the model generation module 104 uses a logistic regression technique to generate the model 112. Background information on one logistic regression technique can be found, for instance, in Andrew et al., “Scalable Training of L¹-Regularized Log-linear Models,” Proceedings of the 24th International conference on Machine Learning, 2007, pp. 33-40. In this approach, the model generation module 104 can perform L1-regularization to produce sparse solutions, thus focusing on features that are most discriminative.

Consider next the use of a confidence-weighted linear classification approach. Background on this technique can be found in Dredze, et al., “Confidence-Weighted Linear Classification,” Proceedings of the 25th International Conference on Machine Learning, 2008, pp. 264-271, and Dredze, et al., “Active Learning with Confidence,” Proceedings of the 46th Annual Meeting of the Association for Computational Linguistics on Human Language Technologies, 2008, pp. 233-236.

In this case, the model generation module 104 generates the model 112 based on feature weights in conjunction with variance. More specifically, the model generation module 104 generates the model 112 using an iterative on-line approach. In this process, the model generation module 104 learns the weights and variances with respect to a probability threshold ψ. That probability threshold ψ characterizes the probability of misclassification, given that the decision boundary is viewed as a random variable with a mean μ and a covariance Σ. Without limitation, in one case, the model generation module 104 can use a probability threshold of ψ=0.90. The outcome of this on-line process is a model 112 which provides a distribution over alter/no-alter decision boundaries. This allows the search engine 102 to quantify the classification uncertainty of any particular prediction.

In one approach, the model generation module 104 can define a variance-adjusted feature weight of:

$${μ}^{*} = μ - \frac{κ}{2} {σ}^{2} .$$

This adjusted feature weight trades off mean and variance. It can be considered as a conservative estimate of the true feature weight μ^{OPT} under uncertainty described by σ². In one non-limiting case, κ is set to 1.

These examples are representative, not exhaustive. The model generation module 104 can use other machine learning techniques to generate the model 112.

C. Representative Processing Functionality

FIG. 17 sets forth illustrative electrical data processing functionality 1700 (also referred to herein as computing functionality) that can be used to implement any aspect of the functions described above. For example, the processing functionality 1700 can be used to implement any aspect of the search engine 102 and/or model generation module 104 of FIG. 1, e.g., as implemented in the embodiment of FIG. 6, or in some other embodiment. In one case, the processing functionality 1700 may correspond to any type of computing device that includes one or more processing devices. In all cases, the electrical data processing functionality 1700 represents one or more physical and tangible processing mechanisms.

The processing functionality 1700 can include volatile and non-volatile memory, such as RAM 1702 and ROM 1704, as well as one or more processing devices 1706 (e.g., one or more CPUs, and/or one or more GPUs, etc.). The processing functionality 1700 also optionally includes various media devices 1708, such as a hard disk module, an optical disk module, and so forth. The processing functionality 1700 can perform various operations identified above when the processing device(s) 1706 executes instructions that are maintained by memory (e.g., RAM 1702, ROM 1704, or elsewhere).

More generally, instructions and other information can be stored on any computer readable medium 1710, including, but not limited to, static memory storage devices, magnetic storage devices, optical storage devices, and so on. The term computer readable medium also encompasses plural storage devices. In all cases, the computer readable medium 1710 represents some form of physical and tangible entity.

The processing functionality 1700 also includes an input/output module 1712 for receiving various inputs (via input modules 1714), and for providing various outputs (via output modules). One particular output mechanism may include a presentation module 1716 and an associated graphical user interface (GUI) 1718. The processing functionality 1700 can also include one or more network interfaces 1720 for exchanging data with other devices via one or more communication conduits 1722. One or more communication buses 1724 communicatively couple the above-described components together.

The communication conduit(s) 1722 can be implemented in any manner, e.g., by a local area network, a wide area network (e.g., the Internet), etc., or any combination thereof. The communication conduit(s) 1722 can include any combination of hardwired links, wireless links, routers, gateway functionality, name servers, etc., governed by any protocol or combination of protocols.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A physical and tangible computer readable medium for storing computer readable instructions, the computer readable instructions providing a model generation module when executed by one or more processing devices, the computer readable instructions comprising:
logic configured to receive query reformulation information that describes query reformulations made by at least one agent;
logic configured to receive preference information which indicates behavior performed by users that pertains to the query reformulations;
logic configured to generate labeled reformulation information based on the query reformulation information and the preference information, the labeled reformulation information indicating an extent to which the query reformulations were deemed satisfactory by the users in fulfilling search objectives of the users; and
logic configured to use a machine learning technique to generate a model based on the labeled reformulation information, the model providing functionality, for use by a search engine, at query time, for mapping at least some search queries to query alterations,
the model comprising a plurality of features having weights associated therewith, each feature defining a rule for altering a search query in a defined manner when a context condition, specified by the rule, is deemed to apply to the search query.

2. The computer readable medium of claim 1, wherein:
said at least one agent comprises at least one user, or a query alteration module, or a combination of said at least one user and the query alteration module;
the preference information comprises implicit preference information, or explicit preference information, or a combination of implicit and explicit preference information;
the behavior performed by the users comprises individual behavior, or aggregate behavior, or a combination of individual behavior and aggregate behavior; and
each search query or search query group maps to zero, one, or more query alterations.

3. The computer readable medium of claim 1, wherein the preference information identifies selections of items by the users after receiving search results, the search results being generated in response to the query reformulations.

4. The computer readable medium of claim 1, further including logic configured to remove noise from the preference information, the noise being associated with tangent selections made by the users, wherein a tangent selection is a selection that does not contribute to satisfying a search objective associated with a search query.

5. The computer readable medium of claim 1, wherein said logic configured to generate the model comprises:
logic configured to identify a plurality of query combinations in the reformulated queries;
logic configured to identify features associated with the query combinations; and
logic configured to generate parameter information based on the features that have been identified.

6. The computer readable medium of claim 1, wherein each context condition of each feature is selected from a set of possible context conditions, and wherein each context condition includes a combination of one or more context components.

7. The computer readable medium of claim 6, wherein at least one type of context condition conveys, at least in part, an inclusion of at least one context component within a query q1 of a query pair (q1, q2).

8. The computer readable medium of claim 6, wherein at least one type of context condition conveys, at least in part, structural information regarding a query q1 of a query pair (q1, q2).

9. The computer readable medium of claim 1, further including uncertainty information associated with individual features, or any combinations of features, or a combination of individual features and any combinations of features.

10. The computer readable medium of claim 1, wherein, in one environment, each weight is diminished based on the level of uncertainty associated therewith, to thereby adopt a conservative interpretation of the weight.

11. The computer readable medium of claim 1, wherein said logic configured to generate a model is configured to generate a logistic regression model.

12. The computer readable medium of claim 1, wherein said logic configured to generate a model is configured to generate a confidence-weighted classification model.

13. A context-aware query alteration module, implemented by a physical and tangible search engine, comprising:
logic configured to receive a search query;
logic configured to identify at least one candidate alteration of the search query, each candidate alteration having a score associated therewith; and
logic configured to generate at least one recommended alteration of the search query, selected from among said at least one candidate alteration, based on the score associated with each candidate alteration,
each candidate alteration matching at least one feature in a set of features specified by a model, each feature defining a rule for altering the search query in a defined manner when a context condition, specified by the rule, is deemed to apply to the search query.

14. The context-aware query alteration module of claim 13, wherein features specified by the model have weights associated therewith, and wherein each score of each candidate alteration is constructed based on at least one weight that is associated with the candidate alteration.

15. The context-aware query alteration module of claim 13, further including uncertainty information associated with individual features of the model, or any combinations of features, or a combination of individual features and any combinations of features.

16. The context-aware query alteration module of claim 13, further comprising logic configured to automatically apply said at least one recommended alteration to searching functionality provided by the search engine.

17. The context-aware query alteration module of claim 13, further comprising logic configured to suggest said at least one recommended alteration to a user who submitted the search query.

18. The context-aware query alteration module of claim 13, wherein the context-aware query alteration module is configured to supplement an operation of other alteration functionality provided by the search engine.

19. A method, implemented by physical and tangible computing functionality, for generating and applying a model for use by a search engine, comprising:
receiving query reformulation information that describes query reformulations made by at least one agent;
receiving preference information which indicates items that have been selected by users in response to the query reformulations;
generating labeled reformulation information using a set of preference-mapping rules, based on the query reformulation information and the preference information, the labeled reformulation information indicating an extent to which query reformulations were deemed satisfactory by the users in fulfilling search objectives of the users;
using a machine learning technique to generate a model based on the labeled reformulation information, the model providing functionality, for use by a search engine, at query time, for mapping search queries to query alterations, the model comprising a plurality of features having weights associated therewith, each feature defining a rule for altering a search query in a defined manner when a context condition, specified by the rule, is deemed to apply to the search query; and
installing the model in the search engine.

20. The method of claim 19, wherein each context condition of each feature is selected from a set of possible context conditions, and wherein each context condition includes a combination of one or more context components.
